(19) United States
(12) Patent Application Publication
(10) Pub. No.: US 2007/0110319 A1
(43) Pub. Date: May 17, 2007

(54) Image processor, method, and program

(75) Inventors: Paul Wyatt, Kanagawa-ken (JP); Hiroaki Nakai, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/595,902

(22) Filed: Nov. 13, 2006

(30) Foreign Application Priority Data
Nov. 15, 2005 (JP) 2005-330605

(51) Int. Cl. G06K 9/48

(52) U.S. Cl. 382/199

(57) ABSTRACT

An image processor, method, and program are provided for detecting edges in an image. In one embodiment, an image processor detects edges from an image while suppressing the effects of noise. Brightness gradient values of each pixel of the image are found for each of a plurality of directions. An amount of noise in the image is estimated based on the brightness gradient values and edge intensities are normalized in order to suppress the effects of the noise.

### BACKGROUND

I. Technical Field

The present invention generally relates to the field of image processing. More particularly, and without limitation, the invention relates to relates to an image processor, method, and program for detecting edges within an image.

II. Background Information

Generally, an image of an object or a scene contains a plurality of image regions. The boundary between different image regions is an “edge.” Typically, an edge separates two different image regions that have different image features. If the image is a gray scale black and white image, then the two image regions may have a different value of brightness. For example, at an edge of the gray scale black and white image, the brightness value varies suddenly between neighboring pixels. Accordingly, edges in images are detectable by determine which pixels vary suddenly in their brightness value and the spatial relationship between these pixels. Spatial variation of the brightness value is referred to as a “brightness gradient.”

For example, the Sobel and Canny techniques, are known image-processing methods in which edges in images are found. In particular, these methods typically involve spatial derivative filters of the first or second order derivative that are convolved with target images. In another method, a combination of these spatial derivative filters is used. Various methods are described by Takagi and Shimoda, “Image Analysis Handbook”, Tokyo University Press, ISBN:4-13-061107-0. In these image-processing methods, the local maximal point of the obtained derivative value is detected as an edge point, i.e., a point at which the brightness varies maximally.

Processing to detect edges involves dividing each image into plural regions. During processing, a fundamental processing step locates only an object to be detected within the image. Processing images to detect edges is a fundamental image-processing technique that is used in industrial fields including object detection, image pattern recognition, and medical image processing. Accordingly, for these industrial applications, it is important to detect edges stably and precisely under various conditions.

However, edge detection techniques relying on currently known methods are easily affected by noise within images. In other words, results of known edge detection techniques are affected by varying local and global contrast and varying local and global signal to noise (S/N) ratios. Accordingly, it is difficult to detect the correct edge set when noise varies among images or among local regions of an image. Furthermore, when edges are detected using known techniques, it is necessary to manually determine an optimum detection threshold value corresponding to an amount of noise in each image or each local region. Consequently, much labor is required in order to process multiple images. Accordingly, there is a need for image-processing systems and methods that detect edges reliably and without errors that are due to noise that is present in images.

### SUMMARY

In one embodiment, the present invention provides an image processor that comprises an image input unit configured to input an image. The image processor further comprises a brightness gradient value-calculating unit configured to calculate a brightness gradient value that indicates a magnitude of variation in brightness at each pixel within the image for each of a plurality of directions. The image processor further comprises an estimation unit that is configured to estimate a first gradient value and a second gradient value using the calculated brightness gradient values. The first gradient value corresponds to a brightness gradient value at the position of each of the pixels within the image in an edge direction. The second gradient value corresponds to a brightness gradient value in a direction perpendicular to the edge direction. The image processor further comprises an edge intensity-calculating unit configured to calculate an edge intensity of each of the pixels using the first and second gradient values of each of the pixels.

In another embodiment, the present invention provides an image-processing method implemented by the above-described processor.

In yet another embodiment, the present invention provides a computer-readable medium storing program instructions for an image-processing method. The method may perform steps according to the above-described processor.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flowchart illustrating an exemplary process for detecting edges, consistent with an embodiment of the present invention;

FIG. 2 is a diagram of an exemplary image in which two image regions are contiguous with each other, consistent with an embodiment of the present invention;

FIG. 3 is a graph of exemplary spatial variations of a brightness value, consistent with an embodiment of the present invention;

FIG. 4 is a graph of exemplary brightness gradient values, consistent with an embodiment of the present invention;

FIG. 5 is a diagram of a direction of an exemplary maximum brightness gradient and a direction of an exemplary minimum brightness gradient, consistent with an embodiment of the present invention;

FIG. 6 is a diagram of exemplary pixel-quantized local image regions, consistent with an embodiment of the present invention;

FIG. 7 is a diagram of an exemplary edge direction in local image regions, consistent with an embodiment of the present invention;

FIG. 8 is another diagram of an exemplary edge direction in local image regions, consistent with an embodiment of the present invention;

FIG. 9 is a further diagram of an exemplary edge direction in local image regions, consistent with an embodiment of the present invention;

FIG. 10 is a yet another diagram of an exemplary edge direction in local image regions, consistent with an embodiment of the present invention;

FIG. 11 is an exemplary original image, consistent with an embodiment of the present invention;

FIG. 12 is an exemplary image of FIG. 11 after being processed to detect edges by a prior art technique;

FIG. 13 is an exemplary image of FIG. 11 after being processed to detect edges by an image-processing method according to a first embodiment of the present invention;

FIG. 14 is a block diagram of an image processor according to a second embodiment of the present invention;

FIG. 15 is a block diagram of an image processor according to a third embodiment of the present invention;

FIG. 16 is a block diagram of an image processor according to a fourth embodiment of the present invention; and

FIG. 17 is an exemplary data table used with the fourth embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

### First Embodiment

An image-processing method associated with a first embodiment of the present invention is described. The image-processing method of the present embodiment may be implemented as a program operating, for example, on a computer. The computer referred to herein is not limited to a PC (personal computer) or WS (workstation). For example, the computer may be a built-in processor. For example, the computer may include a machine having a processor for executing a software program.

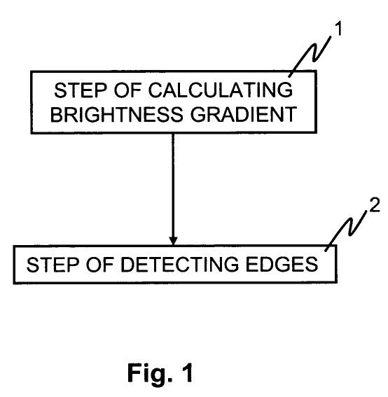

FIG. 1 is a flowchart illustrating an exemplary process for detecting edges by an image-processing method. In step 1, a brightness gradient is calculated. Next, in step 2, edges are detected. Furthermore, step 2 includes a process for estimating local noise and for determining whether the local brightness gradient is significant with respect to this estimate. In particular, referring again to step 1, to calculate a brightness gradient, the method determines brightness gradient values in an edge direction and brightness gradient values in a direction perpendicular to the edge direction. Hereinafter, “the edge direction” means a direction in which an edge continues. In particular, maximum and minimum values are found from brightness gradient values in a plurality of directions. A brightness gradient value indicates a magnitude of variation of spatial brightness (i.e., the brightness value).

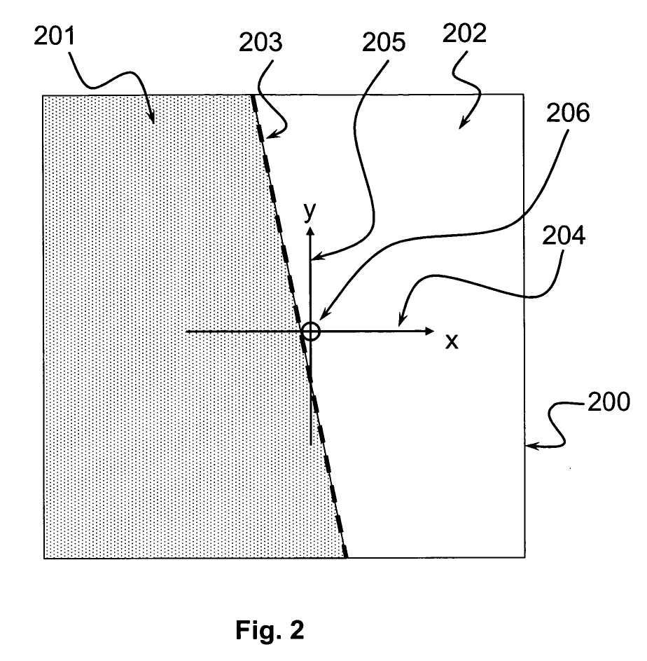

FIG. 2 is an exemplary image 200 that is close to an edge. Image 200 includes a dark image region 201 and a bright image region 202, which are contiguous at a boundary 203. In FIG. 2, variation of brightness near an edge is illustrated by, for example, referring to a pixel 206, which is located close to boundary 203.

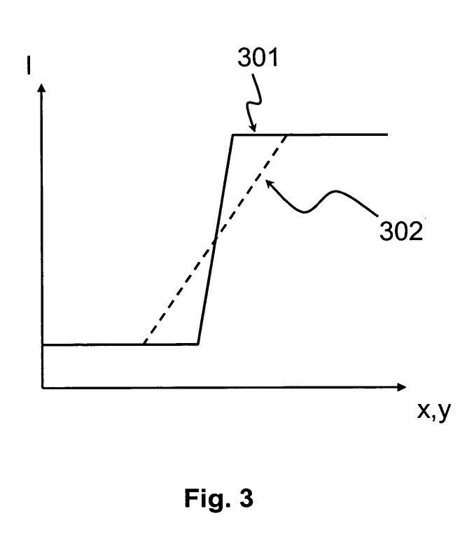

FIG. 3 is an exemplary graph showing variation of the brightness value I in the x-direction and variation of brightness value I in the y-direction near pixel 206.

Referring also to FIG. 2, a solid line 301 indicates variation of the brightness value I along a line 204. Line 204 extends from dark image region 201, intersects boundary 203, and runs toward bright image region 202 in the x-direction. Accordingly, solid line 301 indicates a variation of the brightness value I in the x-direction near pixel 206.

A broken line 302 indicates a variation of the brightness value I along a line 205. Line 205 extends from dark image region 201, crosses boundary 203, and runs toward bright image region 202 in the y-direction. Accordingly, broken line 302 indicates a variation of the brightness value I in the y-direction near pixel 206. The brightness value I is of a low value on the left side of solid line 301 and broken line 302 and of a high value on the right side of sold line 301 and broken line 302.

Generally, images contain blurs and noise and, accordingly, variation of the brightness value I along lines 204 and 205 is often different from an ideal stepwise change. For example, the brightness value often varies slightly near boundary 203, as indicated by solid line 301 and broken line 302.

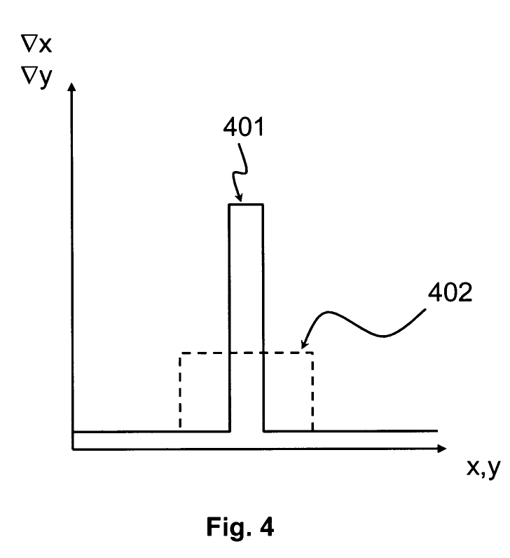

FIG. 4 is an exemplary graph of a first-order derivative value of the brightness value I. A solid line 401 corresponds to the first-order derivative value of solid line 301. The portion of solid line 401 that indicates a high derivative value corresponds to a portion of solid line 301 in which the brightness value/varies suddenly. The derivative value indicated by solid line 401 is referred to as the brightness gradient value in the x-direction and is calculated by ∇I(x)=∂I/∂x.

A broken line 402 in FIG. 4 corresponds to the first-order derivative value of broken line 302. The portion of broken line 402 having a high derivative value corresponds to a portion of broken line 302 in which the brightness value I varies suddenly. The derivative value indicated by broken line 402 is referred to as the brightness gradient value in the y-direction and is calculated by ∇I(y)=∂I/∂y.

In FIG. 2, points having high brightness gradient values are distributed along the boundary 203 between dark image region 201 and bright image region 202. Therefore, edges can be detected by finding brightness gradient values using spatial differentiation and by finding links (continuous distribution) between points having high brightness gradient values.

In FIG. 4, brightness gradient value ∇I(y) is smaller than brightness gradient value ∇I(x) because the y-direction is more closely parallel to the edge direction than the x-direction. Generally, the brightness gradient value increases as it approaches a direction perpendicular to the edge direction and has a maximum value in a direction perpendicular to the edge direction. Conversely, the brightness gradient value has a minimum value in a direction parallel to the edge direction.

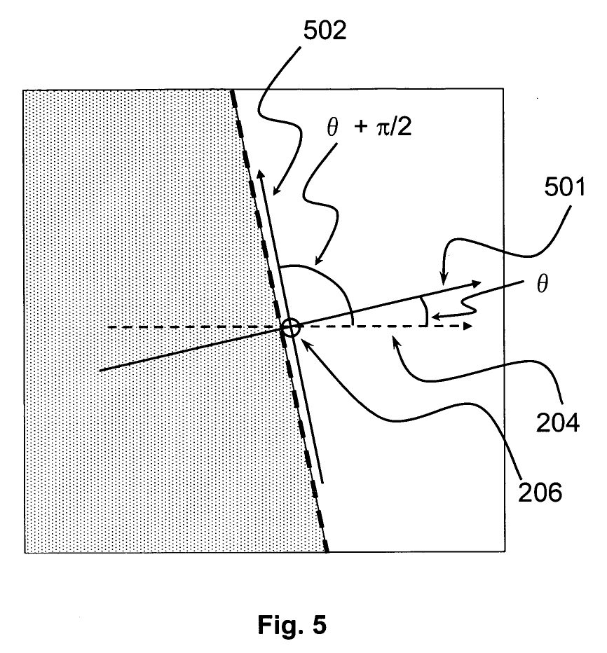

In FIG. 5, the direction perpendicular to the edge direction lies in a direction (θ-direction) that is obtained by rotating the x-direction in a counterclockwise direction through an angle of θ. A line 204 extends in the x-direction. A line 501 extends in the θ-direction. As described previously, the brightness gradient value ∇I(θ) in the θ-direction has a maximum value. That is, ∇I(θ) in the θ-direction is a maximum.

In FIG. 5, the direction parallel to the edge direction is a direction ((θ+π/2)-direction) that has rotated through an angle of (θ+π/2) from the x-direction in a counterclockwise direction. A line 502 extends in the (θ+π/2)-direction. As described previously, the brightness gradient value ∇I(θ+π/2) in the (θ+π/2)-direction has a minimum value.

In the present embodiment, brightness gradient values in a plurality of directions are determined. It is assumed that a direction in which the brightness gradient value maximizes is perpendicular to the edge direction. It is also assumed that a direction in which the brightness gradient value minimizes is parallel to the edge direction.

Referring again to step 1 of FIG. 1, to determine the brightness gradient, brightness gradient values at each point within the image in plural directions are determined. The maximum value ∇I(θ) and minimum value ∇I(θ+π/2) of the determined brightness gradient values are determined.

The brightness gradient value of each pixel in the θ-direction is determined, for example, by taking two points about each pixel in a point symmetrical relationship on a straight line in the 0-direction passing through the pixel and calculating the absolute value of the difference between the brightness values I of the two points. If each of the two points does not correspond to one pixel, estimated values of brightness value I that are determined through interpolation or extrapolation may be used.

Alternatively, the brightness gradient value may be found by approximating the variation in the brightness value I along a straight line in the θ-direction passing through each pixel by a function, differentiating the function to obtain a derivative function, and computing the brightness gradient value from the derivative function.

### Modified Embodiment 1-1

The brightness gradient value in a direction perpendicular to the direction in which the brightness gradient value maximizes may be used as the minimum value ∇I(θ+π/2) of the brightness gradient values. That is, the maximum value ∇I(θ) is determined from brightness gradient values in a plurality of directions. It can be assumed that the brightness gradient value in the direction perpendicular to the direction in which the brightness gradient value maximizes is the minimum value ∇I(θ+π/2) of the brightness gradient values.

### Modified Embodiment 1-2

The brightness gradient value in a direction perpendicular to the direction in which the brightness gradient value minimizes may be used as the maximum value ∇I(θ) of the brightness gradient values. That is, the minimum value ∇I(θ+π/2) is determined from brightness gradient values in a plurality of directions. It can be assumed that the brightness gradient value in the direction perpendicular to the direction in which the brightness gradient value is minimized, is the maximum value ∇I(θ) of the brightness gradient values.

### Modified Embodiment 1-3

In the description of step 1 of FIG. 1 for calculating the brightness gradient in the present embodiment, brightness values within an image are treated as if they vary continuously spatially. In practice, however, the image is made up of a plurality of pixels and the brightness values are spatially quantized. Only a region of 3×3 pixels centered about a pixel of interest within an image is considered.

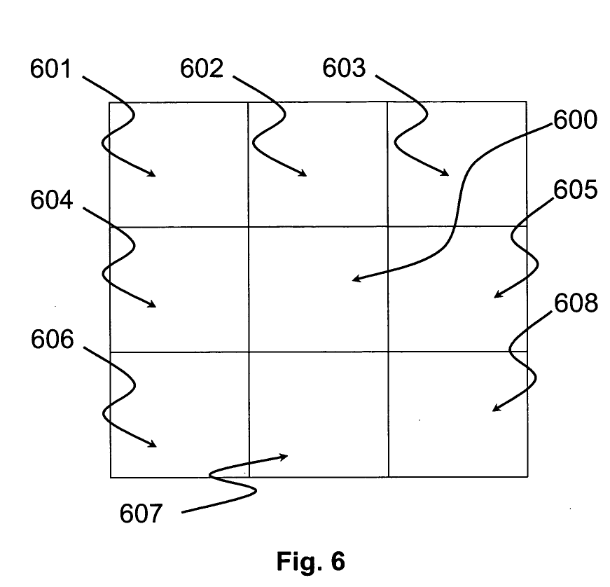

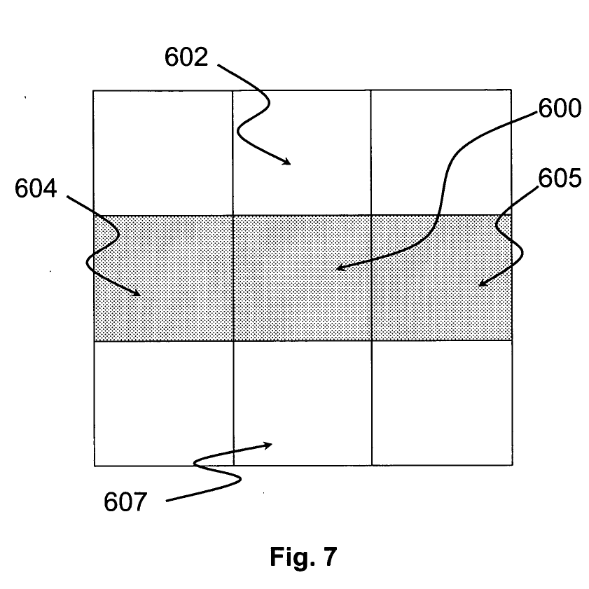

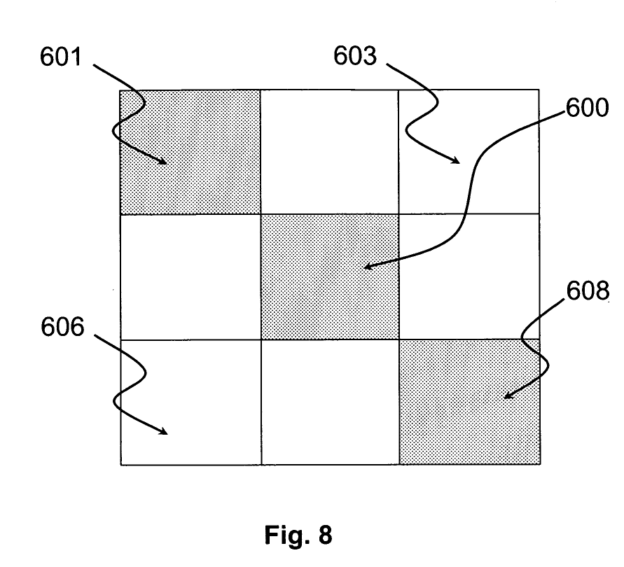

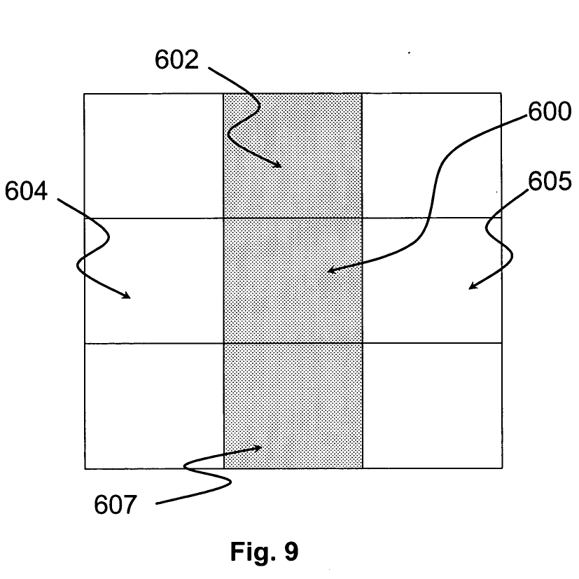

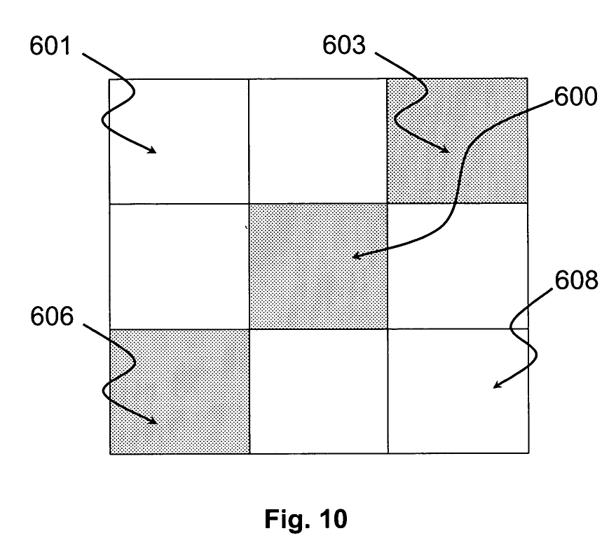

Referring to FIG. 6, there are 8 pixels (from pixel 601 to pixel 608) around a pixel 600 of interest. The positional relationship of the pixel 600 to each of the other pixels is as follows:
left upper portion: pixel 601;
left middle portion: pixel 604;
left lower portion: pixel 606;
top center portion: pixel 602;
bottom center portion: pixel 607;
right top portion: pixel 603;
right center portion: pixel 605; and
right bottom portion: pixel 608.

Where the local region of 3×3 pixels within the image is considered, approximating an edge by a straight line provides an acceptable approximation. Accordingly, with respect to edges passing through pixel 600, four directions that are shown in FIGS. 7-10 are considered. In particular, the four directions are as follows:
FIG. 7: pixel 604→pixel 600→pixel 605;
FIG. 8: pixel 601→pixel 600→pixel 608;
FIG. 9: pixel 602→pixel 600→pixel 607; and
FIG. 10: pixel 603→pixel 600→pixel 606.

Accordingly, the brightness gradient values that need to be determined are the following four:
FIG. 7: pixel 602→pixel 600→pixel 607;
FIG. 8: pixel 603→pixel 600→pixel 606;
FIG. 9: pixel 604→pixel 600→pixel 605; and
FIG. 10: pixel 601→pixel 600→pixel 608.

In calculating brightness gradient values, the difference between pixel values can be used instead of a first-order partial derivative value such as ∂I/∂x. In particular, let I₆₀ₖ be the brightness value of a pixel 60k (k=0, . . . , 8). The four values are found from the following Eq. (1).

$$\begin{matrix}\vert {I}_{602} - {I}_{607} \vert \\ \vert {I}_{603} - {I}_{606} \vert \\ \vert {I}_{604} - {I}_{605} \vert \\ \vert {I}_{601} - {I}_{608} \vert\end{matrix} \} \qquad ( 1 )$$

The method of finding brightness gradient values in an image that has been pixel quantized as described above is not limited to the above-described method of calculating brightness values between pixels existing on a straight line. Any arbitrary method from generally well-known methods of calculating brightness gradient values such as Sobel, Roberts, Robinson, Prewitt, Kirsch, and Canny methods can be used for spatial derivative computation. A specific example is described in the above-described citation by Takagi et al.

### Modified Embodiment 1-4

In the description of the step 1 of FIG. 1 for calculating the brightness gradient in the present embodiment, directions in which brightness gradient values are calculated are set to a plurality of arbitrary directions, and a plurality of brightness gradient values are determined. The direction in which a maximum brightness gradient value is produced can be estimated by determining brightness gradient values in two different directions.

In FIG. 2, line 204 is in the x-direction and line 205 is in the y-direction. Brightness gradient value ∇I(x) in the x-direction and brightness gradient value ∇I(y) in the y-direction are obtained by determining brightness gradient values along each line.

When the brightness gradient values in these two directions are used, the θₘₐₓ-direction in which the brightness gradient value maximizes and the θₘᵢₙ-direction in which the brightness gradient value minimizes are estimated from Eq. (2) below.

$$\begin{matrix}{θ}_{max} = arctan ( \frac{∇ y}{∇ x} ) \\ {θ}_{min} = {θ}_{max} \pm \frac{π}{2}\end{matrix} \} \qquad ( 2 )$$

That is, the θₘₐₓ-direction and θₘᵢₙ-direction can be estimated by calculating brightness gradient values in at least two directions.

If the θₘₐₓ-direction and θₘᵢₙ-direction are estimated, the maximum and minimum values of the brightness gradient values can be obtained, for example, by calculating the brightness gradient value in the θₘₐₓ-direction and the brightness gradient value in the θₘᵢₙ-direction.

### Modified Embodiment 1-5

Instead of using Eq. (2) above, Eq. (3), which follows, may be used. That is, the θₘᵢₙ-direction in which the brightness gradient value minimizes, i.e., the edge direction, can be estimated from brightness gradient values in two different directions.

$$\begin{matrix}{θ}_{min} = arctan ( - \frac{∇ x}{∇ y} ) \\ {θ}_{max} = {θ}_{min} \pm \frac{π}{2}\end{matrix} \} \qquad ( 3 )$$

The maximum and minimum values of brightness gradient values are obtained by calculating brightness gradient values in the edge direction (θₘᵢₙ-direction) and in a direction (θₘₐₓ-direction) perpendicular to the edge direction.

Referring again to step 2 of FIG. 1 for detecting edges, the edge intensity of an arbitrary point or pixel within an image is calculated using the maximum and minimum values of brightness gradient values found in step 1 for calculating brightness gradient. The edge intensity is an index indicating the likelihood of the presence of an edge at a particular point. The edge intensity in the present embodiment corresponds to a probability of existence of an edge.

Let ∇I(θₘₐₓ) and ∇I(θₘᵢₙ) be a maximum value and a minimum value, respectively, of brightness gradient values found in the step 1 for calculating brightness gradient.

If there are spatial brightness value variations originating from edges, brightness gradient values are meaningful values. Generally, an image contains noise. Therefore, spatial derivative values arising from noise are also contained in the brightness gradient values.

Since the minimum value ∇I(θₘᵢₙ) of brightness gradient values is a spatial derivative value in a direction parallel to the edge direction, it can be assumed that brightness gradient values originating from edges are not included in the image and that only spatial derivative values originating from noises are included in the image.

Consequently, the edge intensity P can be found from Eq. (4) using an estimated amount of noise σ and a constant α. The noise σ can be set to ∇I(θₘᵢₙ) or a value based on the integral of this locally.

$$( \frac{⌊ \vert \frac{\partial I}{\partial θ} \vert - {ασ}_{n} ⌋}{\vert \frac{\partial I}{\partial θ} \vert} ) > 0 \qquad ( 4 )$$

Note that the expression

$$⌊ • ⌋ \qquad ( 4 A )$$

indicates that the function is bounded from below by zero. If the noise ασ is greater than the signal, then the numerator has a value of zero. Equation (4) states that the edge intensity is found as a probability of the existence of an edge by subtracting the amount of noise from an edge-derived brightness gradient value and normalizing the difference by the brightness gradient value. In other words, it can also be said that the edge intensity P is an intensity relative to the maximum value ∇I(θₘₐₓ) of brightness gradient values.

Although the constant a is not an arbitrary constant, it may be set to 1 or any arbitrary value. It should be set according to a fraction of noise that it is desired to suppress as determined from the Normal distribution. For example, to suppress 90% of noise, α is set to 1.6449. In this embodiment, α is set to 2.5. In Eq. (4), the effects of the estimated amount of noise σ are adjusted by the constant α. When the estimated amount of noise σ is determined, the effects on the edge intensity P may be taken into account. For example, an amount corresponding, for example, to a α×σ of Eq. (4) may be found as the estimated amount of noise.

Eq. (4) above is an example in which the minimum value ∇I(θₘᵢₙ) of brightness gradient values is used as the estimated amount of noise σ. The estimated amount of noise σ is not limited to the minimum value. Since it can be assumed that the estimated amount of noise is uniform within a local region centered at each pixel, a local region R of area s may be set, and the estimated amount of noise σ may be found as an average value using Eq. (5).

$$σ = \sqrt{\frac{1}{S} {\sum }_{R} {( ∇ {θ}_{min} )}^{2}} \qquad ( 5 )$$

The estimated amount of noise a can be found by any arbitrary method using the minimum value ∇I(θₘᵢₙ) of brightness gradient values, as well as by the above-described method.

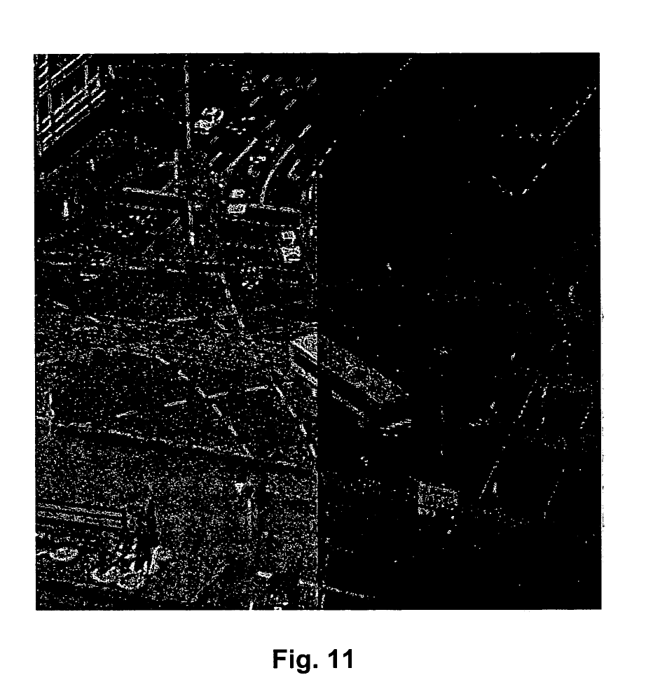

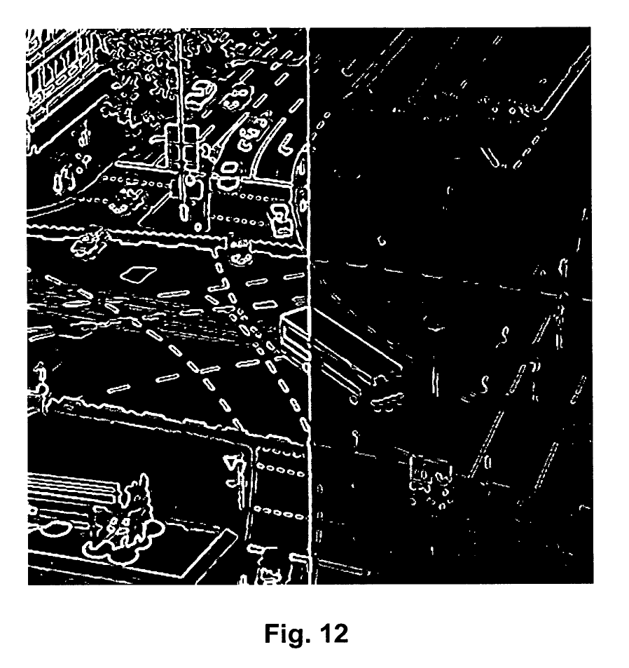

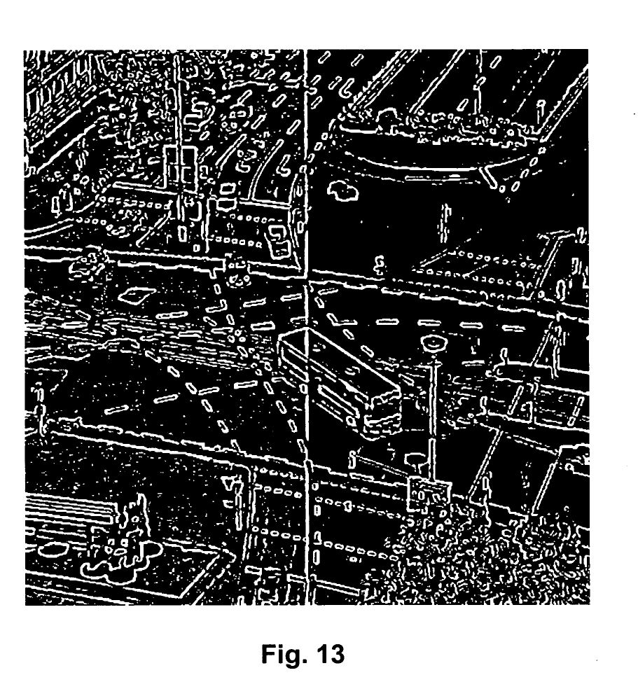

Examples of results of detection of edges based on calculations of the edge intensity P are shown in FIGS. 11-13. FIG. 11 shows an original image. FIG. 12 shows the results of detection using a Canny filter that is a prior art edge detection method. FIG. 13 shows the results of detection using an edge detection method according to the present embodiment. Pixels shown in FIGS. 12 and 13 have edge intensities in pixels as pixel values.

To facilitate an understanding of the effect of the edge detection method according to the present embodiment, the brightness value of each pixel was multiplied by a constant of 0.5 in the right half of FIG. 11, thus producing an image having reduced contrast. Processing to detect edges in this image was performed.

Comparison of the results of detecting edges in FIGS. 12 and 13 reveals that great differences occurred in the right half of the image when the contrast decreased. Since the amount of noise was varied due to the decreased contrast, some edges could not be detected, as shown in FIG. 12 by the prior art edge detection method.

In contrast, in the edge-detecting method according to the present embodiment, edges could be detected stably, as shown in FIG. 13. In particular, as shown in FIG. 13, edge detection was not significantly affected by contrast variation or noise amount variation. Furthermore, in the edge detection method according to the present embodiment, edge intensity is normalized by a maximum value of brightness gradient values. In the final value, the effects of noise have been suppressed. Therefore, when judging whether there are edges, for example, by comparing each edge intensity with a threshold value, the effect of the magnitude of the threshold value on the result of judgment is reduced in comparison to conventional methods. In other words, it is easier to set the threshold value.

### Modified Embodiment 2

In the present embodiment, a method of processing an image has been described. That is, brightness gradient values for brightness values of a gray scale black and white image are determined, and edges are detected. Similar processing for detecting edges can be performed by replacing the brightness gradient values by other feature gradient response values for arbitrary image feature values, as shown below. Examples of the feature amounts are given below.

When an input image is an RGB color image, for example, element values of R (red), G (green), and B (blue) can be used as feature amounts. Each brightness value may be found from a linear sum of the values of R, G, and B. Alternatively, computationally obtained feature mixtures may also be used.

Element values, such as hue H and saturation S in a Munsell color system can be used, as well as an RGB display system. Furthermore, element values of other color systems (such as XYZ, UCS, CMY, YIQ, Ostwald, L*u*v*, and L*a*b*) may be determined and used as feature amounts in a similar fashion. A method of converting between different color systems is described, for example, in the above-described document of Takagi et al.

In one embodiment, results of differentiation or integration in terms of space or time on an image may be used as feature amounts. Mathematical operators used for these calculations include spatial differentiation as described above, Laplacian, Gaussian, and moment operators, for example. Intensities obtained by applying these operators to images can be used as feature amounts.

In another embodiment, noise-removing processing may be performed, for example, by an averaging filter using a technique similar to integration or by a median filter. Such operators and filters are also described in the above document of Takagi et al.

In another embodiment, statistical amounts that can be determined within predetermined regions within an image for each pixel may be used as feature amounts. Examples of the statistical amounts include mean value, median, mode (i.e., the most frequent value of a set of data), range, variance, standard deviation, and mean deviation. These statistical amounts may be found at the 8 neighboring pixel locations for a pixel of interest. Alternatively, statistical amounts found in a region of a previously determined arbitrary form may be used as feature amounts.

Before calculating brightness gradient values, a brightness gradient can be calculated for an arbitrary image scale if a smoothing filter, such as a Gaussian filter having an arbitrary variance value, is applied to the pixels. Precise edge detection can be performed for an arbitrary scale of an image. The smoothing filter may have a size that is relative to the local curvature of the image.

### Second Embodiment

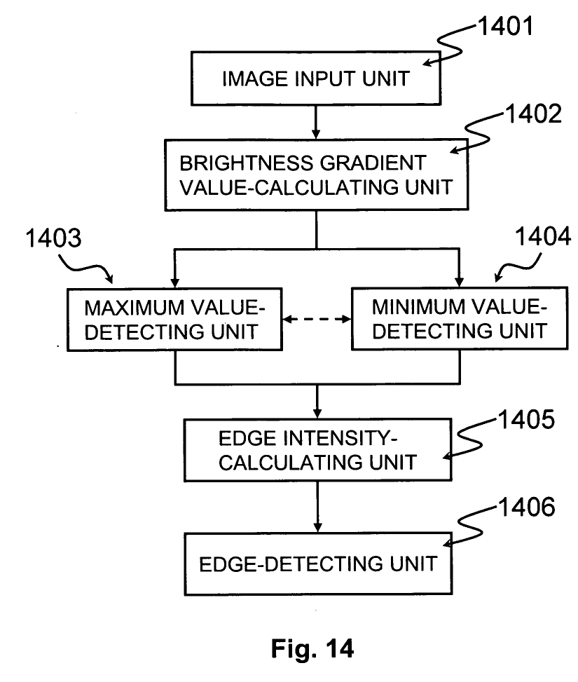

FIG. 14 is a diagram of an image processor according to a second embodiment of the present invention. The image processor according to the present embodiment detects edges from an input image.

The edge detection apparatus shown in FIG. 14 has an image input unit 1401 for inputting an image, a brightness gradient value-calculating unit 1402 for calculating brightness gradient values of each pixel within the image in plural directions, a maximum value-detecting unit 1403 for detecting a maximum value from the determined brightness gradient values, a minimum value-detecting unit 1404 for detecting a minimum value from the found brightness gradient values, an edge intensity-calculating unit 1405 for calculating the edge intensity of each pixel, and an edge-detecting unit 1406 for detecting edges from the image based on the edge intensity of each pixel. The image input unit 1401 accepts as inputs a still or moving image. Where a moving image is input, frames or fields of images may be used.

Brightness gradient value-calculating unit 1402 calculates brightness gradient values of pixels of the image in a plurality of directions. Brightness gradient value-calculating unit 1402 further calculates brightness gradient values in four directions (i.e., a vertical direction, a horizontal direction, a leftwardly downward oblique direction, and a rightwardly downward oblique direction) about each pixel, i.e., gradient values at 4 locations positioned around the pixel. The absolute value of the difference between pixel values is used as each brightness gradient value.

Brightness gradient value-calculating unit 1402 creates information about the brightness gradient in a corresponding manner to brightness gradient values, directions, and pixels. The brightness gradient information is output to maximum value-detecting unit 1403 and to minimum value-detecting unit 1404.

Maximum value-detecting unit 1403 finds a maximum value of the brightness gradient values of each pixel. Minimum value-detecting unit 1404 finds a minimum value of the brightness gradient values of each pixel.

Edge intensity-calculating unit 1405 calculates the edge intensity of each pixel, using the maximum and minimum values of the brightness gradient values of the pixels. Edge intensity-calculating unit 1405 first estimates the amount of noise in each pixel using the minimum value of the brightness gradient values by the above-described technique. Edge intensity-calculating unit 1405 further calculates the edge intensity of each pixel using the amount of noise and the maximum value of brightness gradient values. Edge intensity-calculating unit 1405 creates a map of edge intensities in which the calculated edge intensities are taken as pixel values. The edge intensity map is a gray scale image, for example, as shown in FIG. 13. The pixel value of each pixel indicates the intensity of the edge.

Edge-detecting unit 1406 detects edges within the image using the edge intensity map, and creates an edge map. The edge map is a two-valued image indicating whether the pixel is an edge or not. In particular, edge-detecting unit 1406 judges that the pixel is on an edge if the edge intensity has exceeded a predetermined reference value, and sets a value indicating that the pixel is on an edge into a corresponding pixel value in the edge map. In the present embodiment, edge-detecting unit 1406 binarizes the edge intensity map and determines whether each pixel is on an edge. In other embodiments, as described below, other techniques may be used.

### Modified Embodiment

Minimum value-detecting unit 1404 may refer to detection results of maximum value-detecting unit 1403. That is, detecting unit 1404 can detect a brightness gradient value in a direction perpendicular to the direction in which a maximum gradient value is produced as a minimum value. Maximum value-detecting unit 1403 may refer to detection results of minimum value-detecting unit 1404. That is, a brightness gradient value in a direction perpendicular to the direction in which a minimum brightness gradient value is produced may be detected as a maximum value.

### Third Embodiment

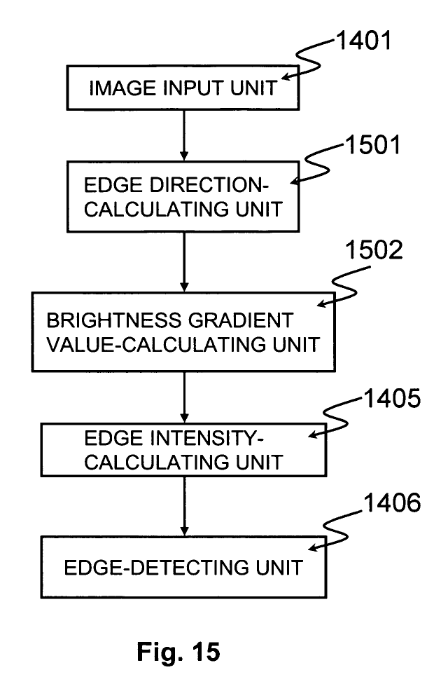

FIG. 15 is a block diagram of an image processor according to a third embodiment of the present invention. The image processor according to the present embodiment detects edges from an input image.

The edge-detecting apparatus shown in FIG. 15 has an image input unit 1401 for inputting an image, an edge direction-calculating unit 1501 for finding an edge direction and a direction perpendicular to the edge in each pixel within the image, a brightness gradient value-calculating unit 1502 for calculating brightness gradient values of each pixel within the image in the edge direction and the direction perpendicular to the edge direction, an edge intensity-calculating unit 1405 for calculating the edge intensity of each pixel, and an edge-detecting unit 1406 for detecting edges from the image based on the edge intensities of the pixels.

The edge-detecting apparatus according to the present embodiment is different from the first embodiment in that brightness gradient values used for computation of edge intensities are calculated after estimating edge directions.

Edge direction-calculating unit 1501 calculates brightness gradient values of each pixel in two different directions. Edge direction-calculating unit 1501 determines the brightness gradient value ∇I(x) in the x-direction and the brightness gradient value ∇I(y) in the y-direction at each pixel, and finds direction θₘₐₓ perpendicular to the edge and edge direction θₘᵢₙ by applying Eq. (2) above.

Brightness gradient-calculating unit 1502 calculates the brightness gradient values of each pixel in the direction perpendicular to the edge and in the edge direction.

Edge intensity-calculating unit 1405 creates an edge intensity map in the same way as in the first embodiment. As described previously, the brightness gradient value in the direction perpendicular to the edge, that is direction θ, corresponds to the maximum value of the brightness gradient values in the first embodiment. The brightness gradient value in the edge direction corresponds to the minimum value of the brightness gradient values in the first embodiment.

### Fourth Embodiment

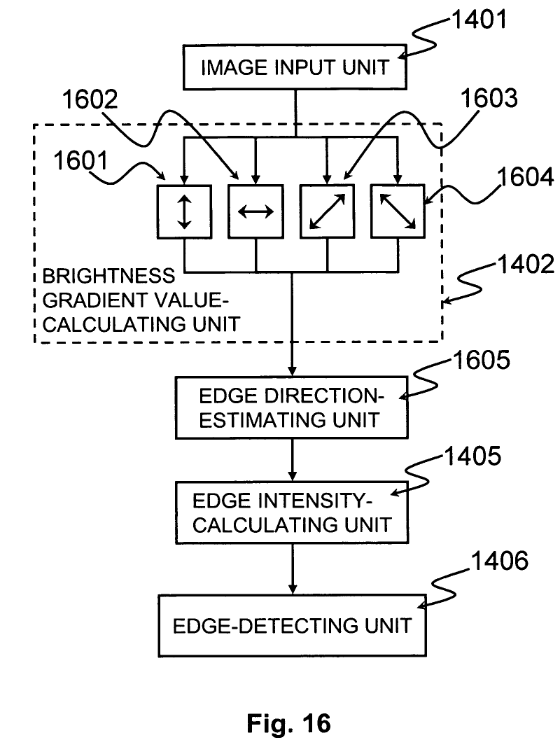

FIG. 16 is a block diagram of an image processor according to a fourth embodiment of the present invention. The image processor according to the present embodiment detects edges from an input image.

The edge-detecting apparatus shown in FIG. 16 has an image input unit 1401 for inputting an image, a brightness gradient value-calculating unit 1402 for calculating brightness gradient values of each pixel within the image in plural directions, an edge direction-estimating unit 1605 for estimating an edge direction by detecting maximum and minimum values from found brightness gradient values, an edge intensity-calculating unit 1405 for calculating the edge intensity of each pixel, and an edge-detecting unit 1406 for detecting edges from the image based on the edge intensities of the pixels.

Brightness gradient value-calculating unit 1402 according to the present embodiment calculates brightness gradient values in four directions (i.e., a vertical direction, a horizontal direction, a first oblique direction (from left bottom to right top), and a second oblique direction (from left top to right bottom)) using pixel information about a region of 3 pixels×3 pixels around each pixel.

Brightness gradient value-calculating unit 1402 according to the present embodiment has first, second, third, and fourth calculators 1601, 1602, 1603, and 1604, respectively. First calculator 1601 calculates the brightness gradient value in the vertical direction. Second calculator 1602 calculates the brightness gradient value in the lateral direction. Third calculator 1603 calculates the brightness gradient value in the first oblique direction (from left bottom to right top). Fourth calculator 1604 calculates the brightness gradient value in the second oblique direction (from left top to right bottom).

The first through fourth calculators 1601-1604 perform calculations corresponding to the above-described Eq. (1) to compute the brightness gradient values of each pixel in each direction. More specifically, first calculator 1601 calculates the difference between the absolute values of pixel values of pixels located above and below, respectively, of each pixel. Second calculator 1602 calculates the difference between the absolute values of pixel values of pixels located to the left and right of each pixel. Third calculator 1603 calculates the difference between the absolute values of pixel values of pixels located on the left and lower side and on the right and upper side, respectively, of each pixel. Fourth calculator 1604 calculates the difference between the absolute values of pixel values of pixels located on the left and upper side and on the right and lower side, respectively, of each pixel.

Edge direction-estimating unit 1605 according to the present embodiment compares the four brightness gradient values found for each pixel and detects maximum and minimum values. In the present embodiment, a direction corresponding to the minimum value is regarded as the edge direction. A direction corresponding to the maximum value is regarded as a direction perpendicular to the edge.

As described previously, there are four edge directions in the region of 3 pixels×3 pixels. The image processor according to the present embodiment can detect edges at a high speed using this property.

### Modified Embodiment

In one embodiment, first calculator 1601 performs calculations corresponding to Eq. (6-1) given below instead of computation of Eq. (1) above. Second calculator 1602 performs calculations corresponding to Eq. (6-2) given below instead of computation of Eq. (1) above.

$$\begin{matrix}\begin{matrix}Δ y = {I}_{602} - {I}_{607} \\ ∇ y = \vert Δ y \vert\end{matrix} \} & ( 6 \text{-} 1 ) \\ \begin{matrix}Δ x = {I}_{605} - {I}_{604} \\ ∇ x = \vert Δ x \vert\end{matrix} \} & ( 6 \text{-} 2 )\end{matrix}$$

More specifically, first calculator 1601 calculates the difference ∇y between the pixel values of pixels located above and below, respectively, of each pixel and the difference ∇I(y) between their absolute values. Second calculator 1602 calculates the difference Δx between the pixel values of pixels located to the left and right, respectively, of each pixel and the difference ∇I(x) between their absolute values.

Edge direction-estimating unit 1605 calculates quantized differences δx and δy by trinarizing the differences Δx and Δy using a threshold value T and based on Eqs. (7-1) and (7-2) given below. The quantized differences δx and δy are parameters indicating to which of positive, zero, and negative values the differences δx and δy are closer.

$$\begin{matrix}δ x \{ \begin{matrix}- 1 & ( Δ x \leq - T ) \\ 0 & ( \vert Δ x \vert < - T ) \\ 1 & ( Δ x \geq - T )\end{matrix} & ( 7 \text{-} 1 ) \\ δ y = \{ \begin{matrix}- 1 & ( Δ y \leq - T ) \\ 0 & ( \vert Δ y \vert < - T ) \\ 1 & ( Δ y \geq - T )\end{matrix} & ( 7 \text{-} 2 )\end{matrix}$$

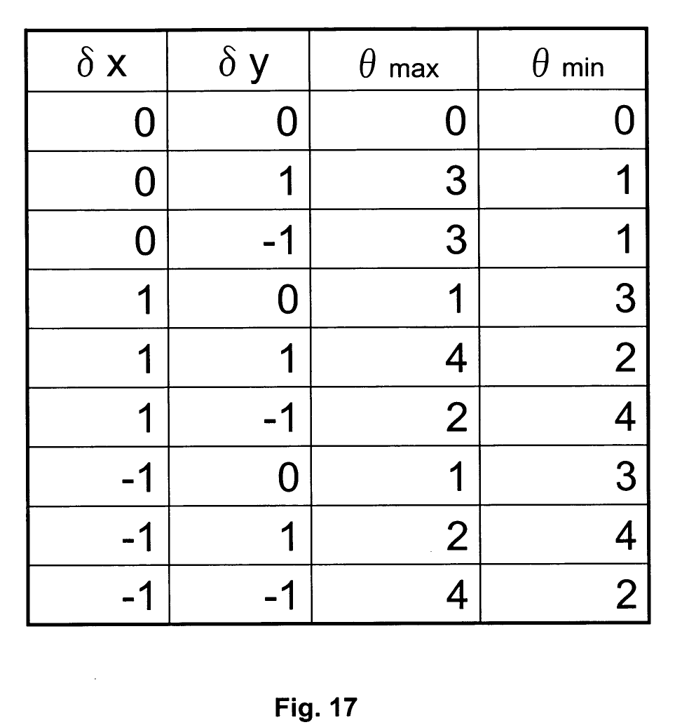

FIG. 17 is an exemplary data table showing the relationships between the quantized differences δx and δy and the directions θₘₐₓ and θₘᵢₙ in which maximum and minimum brightness gradient values are produced, respectively. Values regarding the directions θₘₐₓ and θₘᵢₙ in the table have the following meanings:
1: lateral direction (pixel 604→pixel 600→pixel 605);
2: from left top to right bottom (pixel 601→pixel 600→pixel 608);
3: vertical direction (pixel 602→pixel 600→pixel 607); and
4: from right top to left bottom (pixel 603→pixel 600→pixel 606).

Edge direction-estimating unit 1605 determines directions θₘₐₓ and θₘᵢₙ in which maximum and minimum brightness gradient values are produced, respectively, from the quantized differences δx and δy by referring to the table shown in FIG. 17.

Edge direction-estimating unit 1605 selects values corresponding to the directions θₘₐₓ and θₘᵢₙ, respectively, out of ∇I(θ) in four directions from θ=1 to θ=4 found by the first through fourth calculators 1601-1604, and outputs the values to edge intensity-calculating unit 1405.

In this embodiment, θₘₐₓ is directly found from two different brightness gradient values. If the values of ∇I(θ) in four directions from θ=1 to θ=4 have been found by the first through fourth calculators 1601-1604, ∇I(θₘₐₓ) is determined from the value of θₘₐₓ. That is, calculations performed by maximum/minimum-estimating unit 1605 according to the fourth embodiment compare plural brightness gradient values are omitted.

The foregoing description has been presented for purposes of illustration. It is not exhaustive and does not limit the invention to the precise forms or embodiments disclosed herein. Modifications and adaptations of the invention will be apparent to those skilled in the art from consideration of the specification and practice of the disclosed embodiments of the invention. Further, computer programs based on the present disclosure and methods consistent with the present invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. An image processor, comprising:
an image input unit configured to input an image;
a brightness gradient value-calculating unit configured to calculate a brightness gradient value indicating a magnitude of variation of brightness at each pixel within the image for each of a plurality of directions;
an estimation unit configured to estimate a first gradient value and a second gradient value using the calculated brightness gradient values, wherein the first gradient value corresponds to a brightness gradient value for each of the pixels in the image in an edge direction, and the second gradient value corresponds to a brightness gradient value in a direction perpendicular to the edge direction; and
an edge intensity-calculating unit configured to calculate an edge intensity of each of the pixels using the first and second gradient values of each of the pixels.

2. The image processor of claim 1, wherein the edge intensity-calculating unit calculates the edge intensity by calculating an intensity of a difference between the second gradient value and the first gradient value relative to the second gradient value.

3. The image processor of claim 1, wherein the edge intensity-calculating unit comprises a noise amount-estimating unit configured to estimate an amount of noise in each of the pixels using the first gradient value, and wherein the edge intensity-calculating unit calculates the edge intensity by calculating an intensity of a difference between the second gradient value and the amount of noise relative to the second gradient value.

4. The image processor of claim 3, wherein the noise amount-estimating unit estimates an amount of noise in each of the pixels using an average value of the first gradient values of a plurality of pixels existing within a predetermined range including the pixels within the image.

5. The image processor of claim 1, wherein the brightness gradient value-calculating unit calculates the brightness gradient value of each pixel in the image for a vertical direction, a horizontal direction, a first oblique direction obtained by rotating the vertical direction through 45° in a clockwise direction, and a second oblique direction obtained by rotating the vertical direction through 45° in a counterclockwise direction, and wherein the estimation unit selects the first and second gradient values from the calculated brightness gradient values based on combinations of signs of the brightness gradient values that are calculated in two mutually orthogonal directions.

6. The image processor according to claim 1, wherein the estimation unit includes a direction-estimating unit configured to estimate a direction in which a maximum brightness gradient value is produced using the brightness gradient values calculated in two mutually different directions, and wherein the estimation unit obtains the first gradient value corresponding to a brightness gradient value in the direction estimated by the direction-estimating unit and obtains the second gradient value corresponding to a brightness gradient value in a direction perpendicular to the direction estimated by the direction-estimating unit.

7. The image processor according to claim 1, wherein the estimation unit includes a direction-estimating unit configured to estimate a direction in which a minimum brightness gradient value is produced using the brightness gradient values calculated for two mutually orthogonal directions, and wherein the estimation unit obtains the first gradient value corresponding to a brightness gradient value in a direction perpendicular to the direction estimated by the direction-estimating unit and obtains the second gradient value corresponding to a brightness gradient value in the direction estimated by the direction-estimating unit.

8. A method of processing an image, comprising:
inputting the image;
calculating brightness gradient values indicating a magnitude of variation of brightness of each pixel in the image for each of a plurality of directions;
estimating a first gradient value and a second gradient value using the calculated brightness gradient values, wherein the first gradient value corresponds to a brightness gradient value for each of the pixels in the image in an edge direction, and the second gradient value corresponds to a brightness gradient value in a direction perpendicular to the edge direction; and
calculating an edge intensity of each of the pixels using the first and second gradient values of each pixel.

9. The method of claim 8, wherein the edge intensity is a relative intensity of a difference between the second gradient value and the first gradient value relative to the second gradient value.

10. The method of claim 8, wherein the calculating the edge intensity includes estimating an amount of noise in each of the pixels using the first gradient value, and the edge intensity is a relative intensity of a difference between the second gradient value and the amount of noise relative to the second gradient value.

11. The method of claim 10, wherein estimating the amount of noise in each of the pixels comprises using an average value of the first gradient values of plural pixels existing within a predetermined range including the pixels within the image.

12. The method of claim 8, wherein calculating the brightness gradient values comprises:
calculating brightness gradient values of each pixel in the image about a vertical direction, a horizontal direction, a first oblique direction obtained by rotating the vertical direction through 45° in a clockwise direction, and a second oblique direction obtained by rotating the vertical direction through 45° in a counterclockwise direction; and
selecting the first and second gradient values from the calculated brightness gradient values based on combinations of signs of the brightness gradient values calculated about two mutually orthogonal directions.

13. The method of claim 8, wherein estimating the first and second gradient values comprises:
estimating a direction in which a maximum brightness gradient value is produced using the brightness gradient values calculated about two mutually orthogonal directions;
obtaining the first gradient value corresponding to the maximum brightness gradient value; and
obtaining the second gradient value corresponding to the brightness gradient value in a direction perpendicular to the direction in which the maximum gradient value is produced.

14. The method of claim 8, wherein estimating the first and second gradient values comprises:
estimating a direction in which a minimum brightness gradient value is produced using the brightness gradient values calculated for two mutually orthogonal directions;
obtaining the first gradient value corresponding to the minimum brightness gradient value; and
obtaining the second gradient value corresponding to the brightness gradient value in a direction perpendicular to the direction in which the minimum brightness gradient value is produced.

15. A computer-readable medium storing program instructions for causing a computer to execute a method for processing an image, the method comprising:
inputting the image;
calculating brightness gradient values indicating a magnitude of variation of brightness of each pixel in the image for each of a plurality of directions;
estimating a first gradient value and a second gradient value using the calculated brightness gradient values, wherein the first gradient value corresponds to a brightness gradient value for each of the pixels in the image in an edge direction, and the second gradient value corresponds to a brightness gradient value in a direction perpendicular to the edge direction; and
calculating an edge intensity of each of the pixels using the first and second gradient values of each pixel.

16. The computer-readable medium of claim 15, wherein the edge intensity is a relative intensity of a difference between the second gradient value and the first gradient value relative to the second gradient value.

17. The computer-readable medium of claim 15, wherein the calculating the edge intensity comprises estimating an amount of noise in each of the pixels using the first gradient value, and the edge intensity is a relative intensity of a difference between the second gradient value and the amount of noise relative to the second gradient value.

18. The computer-readable medium of claim 17, wherein estimating the amount of noise comprises estimating the amount of noise in each of the pixels using an average value of the first gradient values of plural pixels existing within a predetermined range including the pixels within the image.

19. The computer-readable medium of claim 15, wherein calculating the brightness gradient values comprises:
calculating brightness gradient values of each pixel in the image about a vertical direction, a horizontal direction, a first oblique direction obtained by rotating the vertical direction through 45° in a clockwise direction, and a second oblique direction obtained by rotating the vertical direction through 45° in a counterclockwise direction; and
selecting the first and second gradient values from the calculated brightness gradient values based on combinations of signs of the brightness gradient values calculated about two mutually orthogonal directions.

20. The computer-readable medium of claim 15, wherein estimating the first and second gradient values comprises:
estimating a direction in which a maximum brightness gradient value is produced using the brightness gradient values calculated about two mutually orthogonal directions;
obtaining the first gradient value corresponding to the maximum brightness gradient value; and
obtaining the second gradient value corresponding to the brightness gradient value in a direction perpendicular to the direction in which the maximum brightness gradient value is produced.

21. The computer-readable medium of claim 15, wherein estimating the first and second gradient values comprises:
estimating a direction in which a minimum brightness gradient value is produced using the brightness gradient values calculated about two mutually orthogonal directions;
obtaining the first gradient value corresponding to the minimum brightness gradient value; and
obtaining the second gradient value corresponding to the brightness gradient value in a direction perpendicular to the direction in which the minimum brightness gradient value is produced.
